(19) United States
(12) Patent Application Publication
(10) Pub. No.: US 2017/0075330 A1
(43) Pub. Date: Mar. 16, 2017

(54) DATA TRANSMISSION SYSTEM, DATA TRANSMISSION APPARATUS AND DATA TRANSMISSION METHOD

(71) Applicant: MITSUBISHI HEAVY INDUSTRIES, LTD., Tokyo (JP)

(72) Inventors: Natsuki MATSUNAMI, Tokyo (JP); Tomohiro TAMI, Tokyo (JP); Masato IEHARA, Tokyo (JP)

(21) Appl. No.: 15/123,477

(22) PCT Filed: Feb. 27, 2015
(86) PCT No.: PCT/JP2015/055945

§ 371 Date: Sep. 2, 2016

(30) Foreign Application Priority Data
Mar. 31, 2014 (JP) 2014-074378

(51) Int. Cl. G05B 19/048; G01S 7/00; G01S 17/42; G08C 17/00; G01S 17/89

(52) U.S. Cl. CPC G05B 19/048; G08C 17/00; G01S 17/89; G01S 17/42; G01S 7/003; G08C 2201/91; G05B 2219/23098

(57) ABSTRACT

A data transmission apparatus (100) selects transmission object data to a remote control terminal (101) based on acquired point group data (20). At this time, an upper limit of a data quantity of the transmission object data in a predetermined region is determined.

### TECHNICAL FIELD

The present invention relates to a data transmission system, a data transmission apparatus, a data transmission method and a data transmission program, and especially to a data transmission apparatus, a data transmission method and a data transmission program, in which three-dimensional point group data are transmitted to a remote apparatus.

### BACKGROUND ART

A technique is known in which a three-dimensional shape is measured by a three-dimensional sensor to acquire point group data (to be also referred to as a point cloud) of points (positions) indicated by the three-dimensional coordinates. A laser scanner and a stereo camera are exemplified as the three-dimensional sensor to acquire the point group data. For example, the laser scanner measures the three-dimensional coordinate positions (the point group data) on the surface of a measurement object based on the laser irradiation light and the reflected light. Specifically, the laser scanner acquires the three-dimensional coordinate positions on the surface of the measurement object based on the round-trip time of the laser beam between the measurement object and the sensor and the irradiation angle of the laser beam. At this time, by synthesizing the point group data with color data acquired by a camera provided separately from the laser scanner and so on, it is possible to make it easy to visibly recognize the three-dimensional shape of the measurement object.

Generally, because there are a large quantity of point group data acquired by the three-dimensional sensor, processing of reducing the data quantity of the point group data is carried out to reduce a calculation quantity, when analyzing the point group data and modeling the three-dimensional shape. For example, the point group data are acquired while changing a scan position, and the point group data in each scan position are synthesized to obtain the shape in a wide region. In such a case, the positioning (the matching processing) of the acquired point group data must be carried out. In this case, in order to reduce the calculation quantity in the matching processing, the data quantity of the point group data is reduced. The technique of reducing the data quantity of point group data for the matching processing is disclosed in, for example, “Fast range-independent spherical subsampling of 3D laser scanner points and data reduction performance evaluation for scene registration” (Non-Patent Literature 1).

In Non-Patent Literature 1, the technique of reducing the point group data for a data interval to become constant in a spherical coordinate system is disclosed. To carry out the matching processing, the point group data needs to be reduced while the shape data of the object is maintained. For this reason, in the technique disclosed in Non-Patent Literature 1, the number of the point group data is reduced so that the interval between the point group data after the reduction become as constant as possible over the whole data measuring range.

Also, because there are a large quantity of point group data, a long time is required when all the measured point group data are transmitted to the other apparatus. For example, when the three-dimensional scanner is loaded in a traveling-type robot which is controlled by a remote control terminal, the shape (e.g. a peripheral landform) around the traveling-type robot is transmitted to the remote control terminal as the point group data. A user who operates the remote control terminal can grasp a situation of the periphery of the traveling-type robot and instruct the next operation of the traveling-type robot by processing the transmitted point group data and producing a shape image (e.g. a landform image). At this time, when taking a long transmission time of the point group data, a time necessary to instruct the next operation of the traveling-type robot becomes long, resulting in prolongation of a mission performing time of the robot. Therefore, when the point group data is transmitted to the remote control terminal from the traveling-type robot, it is required to reduce the data quantity of the point group data and to shorten the transmission time of the point group data. Especially, when the propagation environment of a data transmission path is bad between the traveling-type robot and the remote control terminal (for example, when the transmission capacity is small), it is strongly required to reduce the data quantity of the point group data.

Moreover, when carrying out a remote operation, it is necessary to ensure the visibility to the peripheral landform of the robot. Therefore, it is required to reduce the point group data to be transmitted while maintaining the visibility.

### CITATION LIST

[Non-patent Literature 1] Anthony Mandow, et al., “Fast range-independent spherical subsampling of 3D laser scanner points and data reduction performance evaluation for scene registration”, (Journal Pattern Recognition Letters, Vol. 31, Issue 11, Aug. 1, 2010, Pages. 1239-1250)

### SUMMARY OF THE INVENTION

An object of the present invention is to provide a data transmission system, a data transmission apparatus, a data transmission method and a data transmission program, which can reduce a data quantity of point group data to be transmitted to a remote control terminal.

The data transmission apparatus according to some embodiments includes an actuator, a three-dimensional sensor, a processing unit (a data selecting section) and a communication section. The actuator is controlled in response to a control signal from a remote operation apparatus. The point group data showing the three-dimensional coordinates are acquired by the three-dimensional sensor. The processing unit selects transmission object data based on the point group data. The communication section transmits the selected transmission object data to the remote control terminal. Here, the processing unit sets an upper limit of a data quantity of the transmission object data belonging to a predetermined three-dimensional region.

A data transmission method according to some embodiment is a data transmission method by a data transmission apparatus having an actuator controlled in response to a control signal from a remote control terminal and includes the following steps. That is, the data transmission method includes acquiring point group data showing three-dimensional coordinates; selecting transmission object data based on the point group data; and transmitting the transmission object data to the remote control terminal. The processing unit of the data transmission apparatus sets an upper limit of a data quantity of the transmission object data belonging to a predetermined three-dimensional region.

According to the present invention, the data quantity of the point group data to be transmitted to the remote control terminal can be reduced.

### BRIEF DESCRIPTION OF THE DRAWINGS

The attached drawings are incorporated into this Specification to help the description of embodiments. Note that the drawings should not be interpreted to limit the present invention to shown examples and described examples.

FIG. 1 is a diagram showing an example of the configuration of a data transmission system according to an embodiment.

FIG. 2 is a diagram showing an example of point group data acquired by a robot according to the embodiment.

FIG. 3 is a block diagram showing an example of the data transmission system according to the embodiment.

FIG. 4 is a conceptual diagram of a measurement object and the point group data acquired by the robot according to the embodiment.

FIG. 5 is a diagram showing an example of a grid which is arranged on the point group data acquired by the robot according to the embodiment.

FIG. 6 is a diagram showing an example of a method of reducing transmission data according to the embodiment.

FIG. 7 is a diagram showing the method of reducing the transmission data in a first embodiment.

FIG. 8 is a diagram showing an example of the point group data acquired by the robot according to the embodiment.

FIG. 9 is a diagram showing an arrangement example of the grid to the point group data in transmission data reduction processing according to the embodiment.

FIG. 10 is a diagram showing an example of the method of reducing the transmission data according to the first embodiment.

FIG. 11 is a diagram showing another example of the method of reducing the transmission data according to the first embodiment.

FIG. 12 is a diagram showing an example of the point group data after reducing the data quantity of the transmission data according to the first embodiment.

FIG. 13 is a diagram showing another example of the method of reducing the transmission data according to the first embodiment.

FIG. 14 is a diagram showing another example of the point group data after reducing the data quantity of the transmission data according to the first embodiment.

FIG. 15 is a diagram showing a reduction example of a transmission data quantity when the point group data are distributed in one dimension in the method of reducing the transmission data according to a second embodiment.

FIG. 16 is a diagram showing a reduction example of the transmission data quantity when the point group data are distributed 2-dimensionally in the method of reducing the transmission data according to the second embodiment.

FIG. 17 is a diagram showing a reduction example of the transmission data quantity when the point group data are distributed three-dimensionally in the method of reducing the transmission data according to the second embodiment.

### DESCRIPTION OF EMBODIMENTS

Hereinafter, embodiments will be described with reference to the attached drawings. In the following detailed description, many detailed specific items are disclosed for the purpose of the description in order to provide the comprehensive understanding of the embodiments. However, it would be apparent that one or more embodiments are executable without these detailed specific items.

### (Overview)

A data transmission system according to some embodiments selects transmission object data from between point group data acquired by a remote-controlled robot. An upper limit is set to a quantity of a part selected as the transmission object data, of the point group data which belongs to a predetermined three-dimensional region. Thus, sparse and dense of the transmission object data selected from the point group data of the predetermined three-dimensional region can be controlled. Therefore, the sparse and dense of the transmission object data (data to be transmitted of the point group data) which shows the shape of a measurement object while reducing the traffic can be optionally selected. For example, the measurement object is virtually covered with a three-dimensional grid, and the point group data in the grid are reduced according to a predetermined algorithm. The robot transmits the point group data (the transmission object data) of the reduced data quantity to the remote control terminal. The remote control terminal produces a shape image around the robot based on the received point group data to visibly output to a display unit and so on. A user controls the operation of the robot by operating the remote control terminal while viewing the shape image around the robot.

### (Configuration)

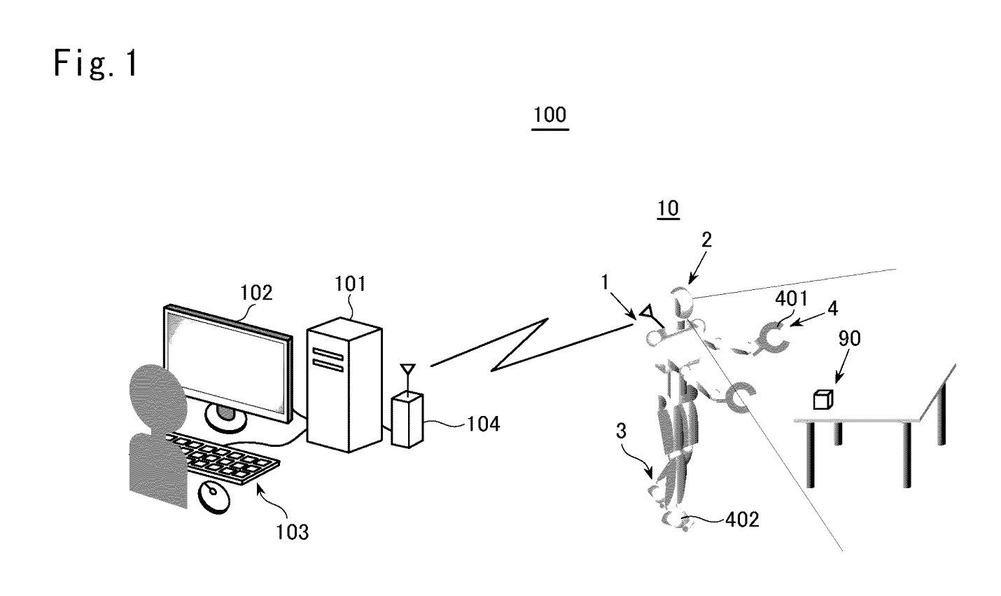

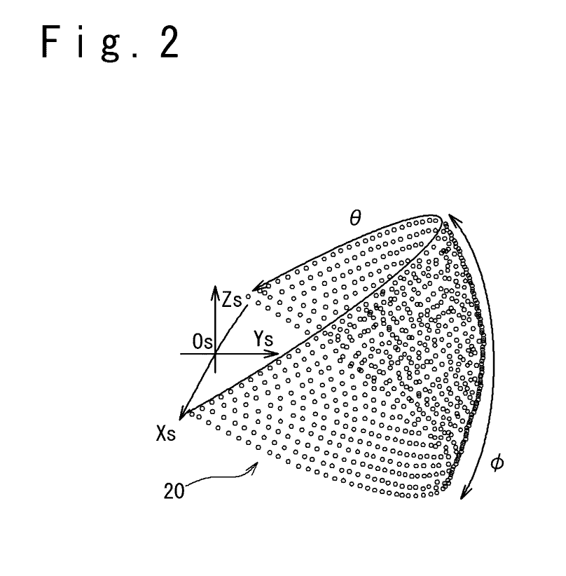

Referring to FIG. 1 and FIG. 2, an example of the configuration of a data transmission system 100 according to an embodiment will be described. FIG. 1 is a diagram showing an example of the configuration of the data transmission system 100. FIG. 2 is a diagram showing an example of point group data acquired by the robot.

Referring to FIG. 1, the data transmission system 100 includes a remote control terminal 101 and a robot 10. The robot 10 travels in response to an instruction (a control signal) from the remote control terminal 101. Alternatively or additionally, the operation of an arm section 4 (a manipulator) of the robot to be mentioned later is controlled in response to an instruction (a control signal) from the remote control terminal 101. For example, in response to the instruction from the remote control terminal 101, the robot 10 carries out the operation of “traveling to the neighborhood of a target object 90 and moving the target object 90 from a current position to another position”. At this time, the robot 10 transmits point group data 20 of the peripheral region acquired by a three-dimensional sensor 2 (i.e. a sensor to acquire a three-dimensional shape) to the remote control terminal 101. The user operates the remote control terminal 101 to instruct a next operation to the robot 10, while confirming a surface shape image around the robot 10 generated based on the point group data 20.

Hereinafter, referring to FIG. 1 and FIG. 2, the details of the configuration of the data transmission system 100 will be described.

The remote control terminal 101 is connected with an output unit 102, an input unit 103, and a transmission unit 104. The remote control terminal 101 is exemplified by a computer system and includes a CPU and a storage unit (not shown). The remote control terminal 101 controls the operation of the robot 10, and generates a surface shape image of a measurement object based on the point group data 20 transmitted from the robot 10 to visibly output to the output unit 102. The details of the configuration of the remote control terminal 101 will be described later. The output unit 102 is exemplified by a monitor and a printer, and visibly outputs image data outputted from the remote control terminal 101. The input unit 103 is exemplified by a keyboard, a touch panel, a mouse, a joystick and so on, and is an interface unit which inputs various data generated by the operation of the user to the remote control terminal 101. The transmission unit 104 is a communication interface unit which controls the transmission of data and signals between the remote control terminal 101 and (a transmission unit 1 of) the robot 10. In details, the transmission unit 104 builds a transmission line with the transmission unit 1 loaded on the robot 10 by either of a radio line or a wired line or both lines, and controls the data transmission between the remote control terminal 101 and the robot 10.

Note that the remote control terminal 101, the output unit 102, the input unit 103, and the transmission unit 104 may be provided as individual units as shown in FIG. 1. However, all the units (or elements) may be provided as a unitary device, or at least two of all the units (or elements) may be provided as a unitary device. For example, the integration of the output unit 102 and the input unit 103 can be realized as a touch panel. Also, the integration of the remote control terminal 101 and the transmission unit 104 can be realized as a computer system with a communication function. Furthermore, as the integration of all of the remote control terminals 101, the output units 102, the input units 103, and the transmission unit 104, a mobile phone of a touch panel type (generally, called a smartphone), a PDA with communication function (Personal Digital Assistants), and so on are exemplified.

The robot 10 has a transmission unit 1, a three-dimensional sensor 2, a leg section 3, and an arm section 4. The robot 10 functions as a data transmission apparatus in which a data quantity of the point group data 20 acquired through the measurement by the three-dimensional sensor 2 is reduced based on predetermined algorithm, such that the reduced point group data 20 is transmitted to the remote control terminal 101. In other words, the robot 10 is one embodiment of the data transmission apparatus.

The transmission unit 1 is an interface unit which controls the transmission of data and signals between the robot 10 and the remote control terminal 101. In detail, the transmission unit 1 builds a transmission path with the transmission unit 104 connected with the remote control terminal 101 by either of a radio line or a wired line or both lines, and controls the data transmission between the robot 10 and the remote control terminal 101.

The three-dimensional sensor 2 is exemplified by a laser scanner and a stereo camera, and acquires the three-dimensional position coordinates on the surface of the measurement object around the robot 10 as the point group data 20 (to be also referred to as a point cloud). For example, the laser scanner which can be used as the three-dimensional sensor 2 acquires the point group data 20 by one method of a trigonometry method, a time-of-flight method, and a phase difference method (phase-shift method).

Referring to FIG. 2, an example of a measurement range (a scan range) of the point group data 20 by the three-dimensional sensor 2 will be described. Here, it is supposed that the measurement position of the three-dimensional sensor 2 (e.g. a setting position) is an origin Os, and the coordinate system of the measured point group data 20 is expressed by (Xs, Ys, Zs). The three-dimensional sensor 2 scans a laser in a range of azimuth angle θ and an elevation angle (I) around the origin Os, and measures (or acquires) the three-dimensional coordinate points on the surface of the measurement object as the point group data 20 based on the reflected light from the measurement object in this range. The robot 10 travels using the leg section 3, and measures the point group data 20 in a plurality of positions (i.e. the plurality of positions of the three-dimensional sensor), and acquires the point group data 20 within a desired range by matching-synthesizing the measured point group data 20.

Referring to FIG. 1, the leg section 3 is driven by an actuator 16 to be mentioned later, and is a moving means for moving the robot 10 to an optional position. In the present embodiment, a leg having joints and links as the leg section 3 will be described as an example. However, a rotation body (e.g. wheels) which is rotated by a motor and an engine may be loaded on the robot 10 as the leg section 3. The number of legs, the shape of each leg, and the number of joints (the number of links) in the leg section 3 are not limited to the number and the shape shown in the drawings and it is possible to optionally set them. The arm section 4 is driven by the actuator 16 to be mentioned later, and is exemplified by a manipulator (to be also referred to as an arm) having the joints, the links and an end effector 401. It is desirable that the end effector 401 is provided for the tip of the arm section 4, and has a mechanism which gives a physical operation (a dynamic operation, an electromagnetic operation, a thermodynamic operation) to the object. Specifically, the end effector 401 may have a mechanism for holding, painting, or welding the object. Alternatively or additionally, the end effector 401 may have an electromagnetic sensor, various measurement devices and so on. In an example shown in FIG. 1, the robot hand which holds (handles) the object is provided for the arm section 4 as the end effector 401. The number of arms in the arm section 4, the shape of it, the number of joints (the number of links), and the configuration of the end effector 401 are not limited to the above-mentioned number, shape and so on shown in FIG. 1, and they are possible to set optionally.

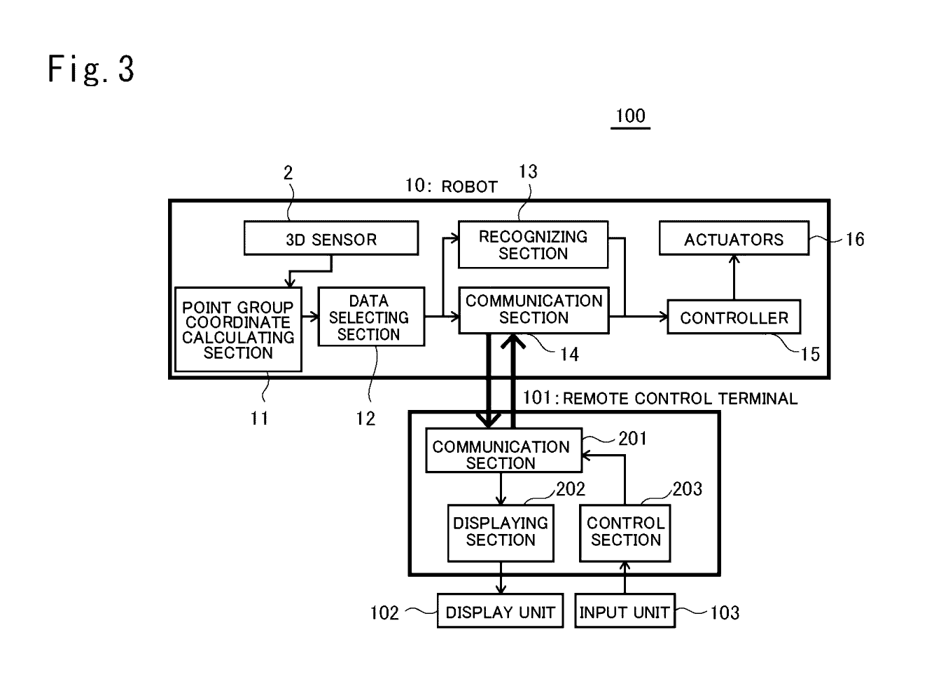

Referring to FIG. 3, the details of the configuration of the remote control terminal 101 and the robot 10 will be described. In the remote control terminal 101, the functions of a communication section 201, a displaying section 202 and a control section 203 are realized by a CPU executing a program stored in a storage unit (not shown). Each function of the communication section 201, the displaying section 202 and the control section 203 may be realized by only the hardware, or a cooperation of the software and the hardware. For example, the communication section 201 includes a communication interface (hardware).

The communication section 201 controls the transmission unit 104 shown in FIG. 1 and controls communication with the transmission unit 1 of the robot 10. In detail, the communication section 201 transmits a control signal from the control section 203 to the transmission unit 1 of the robot 10 through the transmission unit 104, or outputs the point group data 20 (the signal corresponding to the point group data 20) transmitted from the robot 10 to the displaying section 202. The displaying section 202 generates image data to be displayed on the output unit 102. In detail, the displaying section 202 generates and outputs the image data for the surface shape of the measurement object to the output unit 102 by using the point group data 20 supplied from the communication section 201. For example, the displaying section 202 calculates the image data to display the surface shape of the measurement object through processing of various types such as edge detection, smoothing by noise removal, and normal line extraction to the point group data 20. The control section 203 generates and outputs a control signal in response to an input signal from the input unit 103 to the communication section 201. The robot 10 controls the operations of the leg section 3, the arm section, an acquiring operation of the point group data 20 and so on in response to the control signals outputted from the control section 203.

The robot 10 includes a computer system (for example, the computer system contains a processing unit including a CPU and so on and a storage unit) not shown. By the CPU executing a program stored in the storage (not shown) in the robot 10, each of the functions of a point group coordinate calculating section 11, a data selecting section 12, a recognizing section 13, a communication section 14 and a controller 15 is realized. Each function of the point group coordinate calculating section 11, the data selecting section 12, the recognizing section 13, the communication section 14 and the controller 15 may be realized by only the hardware, or the cooperation of the software and the hardware. By the computer system (the processing unit containing the CPU) executing the above-mentioned program, processing of types such as point group data acquisition processing, point group data selection processing, and surface shape calculation processing is realized.

The point group coordinate calculating section 11 (a processing unit) calculates the three-dimensional position coordinates (X, Y, Z) of the measurement points as the point group data 20 by using a distance between the measurement object and the sensor and an irradiation angle (a reflection angle) which are measured by the three-dimensional sensor 2 (in other words, the point group coordinate calculating section 11 executes the point group data acquisition processing which calculates the three-dimensional position coordinates of the measurement points measured by the three-dimensional sensor 2 as the point group data 20). Also, the point group coordinate calculating section 11 may carry out matching processing of the point group data 20 obtained by the three-dimensional sensor 2 in a plurality of positions and extract as the point group data 20 of the whole measurement range. The point group data 20 calculated by the point group coordinate calculating section 11 are outputted to the data selecting section 12. Here, the robot 10 may have a CCD camera to acquire color data (RGB) so as to improve the visibility of the landform around the robot and the shape of the measurement object, in addition to the three-dimensional sensor 2. In this case, the point group coordinate calculating section 11 may synthesize the point group data 20 and the color data (carry out color matching). However, in order to reduce a data quantity of transmission data to the remote control terminal 101 or to reduce a calculation quantity in the robot 10, the point group data 20 and the color data may be transmitted to the remote control terminal 101 from the robot 10 at the different timings, and the color matching may be carried out in the remote control terminal 101.

The data selecting section 12 (the processing unit) executes the point group data selection processing of selecting the point group data 20 to be transmitted to the remote control terminal 101 from among the point group data 20 acquired by the point group coordinate calculating section 11. At this time, it is desirable that the data selecting section 12 sets a predetermined region, and determines an upper limit of the data quantity of the transmission data in the region.

The data selecting section 12 arranges a grid in a virtual space, in which the point group data 20 acquired from the point group coordinate calculating section 11 are distributed, (to divide the virtual space into predetermined three-dimensional grid regions), and reduces the number of point group data 20 which belongs to each cell of the grid 30 according to predetermined algorithm (the point group data selection processing). The data selecting section 12 outputs the point group data 20 of the transmission object data which belongs to each cell of the grid 30, to the communication section 14. The data selecting section 12 may select the point group data 20 of the transmission object data (registered in the grid 30) as the point group data 20 to be transmitted in a high priority earlier than the other point group data 20. In this case, the point group data 20 which are not selected in the selection processing may be outputted to the communication section 14 as data with a low priority. It is desirable that the point group data 20 selected by the data selecting section 12 and the entire point group data 20 before selected are recorded in the storage unit (not shown). The details of the point group data selection processing by the data selecting section 12 will be described later.

Also, the data selecting section 12 may analyze the point group data 20 in the predetermined region, and select data obtained based on the analysis result, as the transmission object data. The details of a method of acquiring the data obtained based on the analysis result of the point group data 20 will be described later.

It is desirable that the data selecting section 12 outputs all of the point group data 20 acquired from the point group coordinate calculating section 11 (the point group data 20 before the selection) to the recognizing section 13. However, the data selecting section 12 may output the point group data 20 selected as the transmission object data, to the recognizing section 13.

The recognizing section 13 executes surface shape calculation processing of analyzing the point group data 20, and calculating the surface shape of the measurement object in the region measured by the three-dimensional sensor 2 (the region in which the point group data 20 of the analysis object are distributed). The recognizing section 13 outputs the data showing the calculated surface shape, to the controller 15. This data is desirable to be recorded in the storage unit (not shown). The data of the surface shape obtained here contains, for example, the peripheral landform of the measured region and data showing the detailed position coordinates of the target object 90.

The controller 15 controls the operation of the actuator 16 in response to an operation command signal which is generated based on the control signal supplied from the remote control terminal 101 through the communication section 14. In detail, the controller 15 receives the control signal (for example, data showing a target position and a target attitude) from the remote control terminal 101 to move the leg section 3, the arm section 4 or the like to a desired position. The controller 15 controls the actuator 16 in response to the control signal such that the leg section 3, the arm section 4 and so on take the position and attitude instructed from the remote control terminal 101. At this time, an operation quantity and operation direction of the actuator 16 may be corrected based on the data showing the surface shape of the measurement object outputted from the recognizing section 13 (for example, the surface coordinates of the measurement object), and the position coordinates of the link or the end effectors 401 and 402 in the leg section 3 or the arm section 4.

The controller 15 may autonomously determine the operation quantity and operation direction of the actuator 16 to control the operation of the robot 10, by using the surface coordinates of the measurement object outputted from the recognizing section 13, and the position coordinates of the link or the end effectors 401 and 402 in the leg section 3 or the arm section 4. In this case, the controller 15 may use not the point group data 20 selected as the transmission object data but data of the detailed surface shape calculated in the recognizing section 13, in order to carry out the improvement of the operation precision and the detailed analysis of a traveling route.

The actuator 16 is exemplified by a servo motor, a power cylinder, a linear actuator, a rubber actuator and so on, and controls a mechanical conduct of the leg section 3, the arm section 4 and so on in response to an operation command signal from the controller 15. The actuator 16 may drive the leg section 3, the arm section 4 and so on directly or indirectly. That is, the actuator 16 may be provided separately from the leg section 3 or the arm section 4 and may be loaded as a part of the leg section 3, the arm section 4 and so on (e.g. the joint section). Also, when the leg section 3 is a rotating body which is exemplified by a wheel, a motor or an engine may be used as the actuator 16.

### (Method of Reducing Transmission Data Quantity)

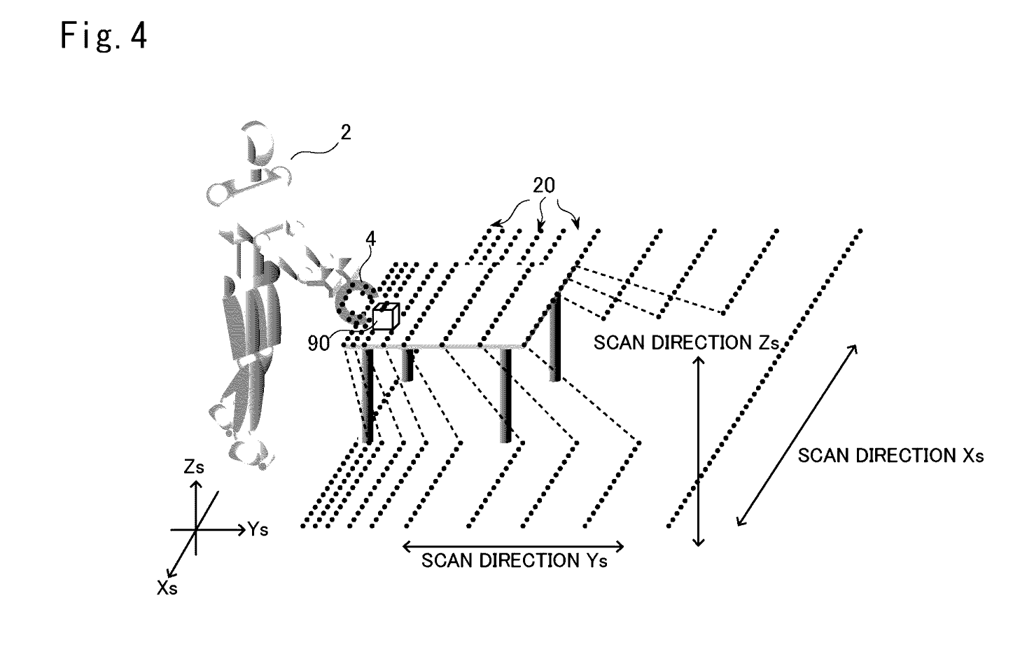

Referring to FIG. 4 to FIG. 17, the details of the method of reducing a transmission data quantity in the data transmission system 100 will be described. Referring to FIG. 4 to FIG. 6, the basic embodiment of the method of reducing a data quantity will be described.

FIG. 4 is a conceptual diagram of the point group data 20 acquired by the robot 10 and the measurement object. Referring to FIG. 4, the robot 10 acquires the point group data 20 of the measurement object by the three-dimensional sensor 2. The measurement object is, for example, an element of reflecting a laser beam in the scan range of the three-dimensional sensor 2, and includes a peripheral landform and the target object 90 in the scan range. When the point group data 20 measured in a plurality of positions are synthesized to acquire the point group data 20 in a wide region, it is desirable that the point group data 20 are expressed in a rectangular coordinate system (Xs, Ys, Zs). For example, when the point group data 20 measured in the measurement point Os are shown on the polar coordinate system as shown in FIG. 2, the point group data 20 is desirable to be changed to data in the rectangular coordinate system (Xs, Ys, Zs). Also, it is desirable that a scan coordinate system (Xs, Ys, Zs) to which the point group data 20 belongs is the absolute coordinate system which is the same as a coordinate system in which the position coordinates of the robot 10, the leg section 3 and the arm section 4 are expressed.

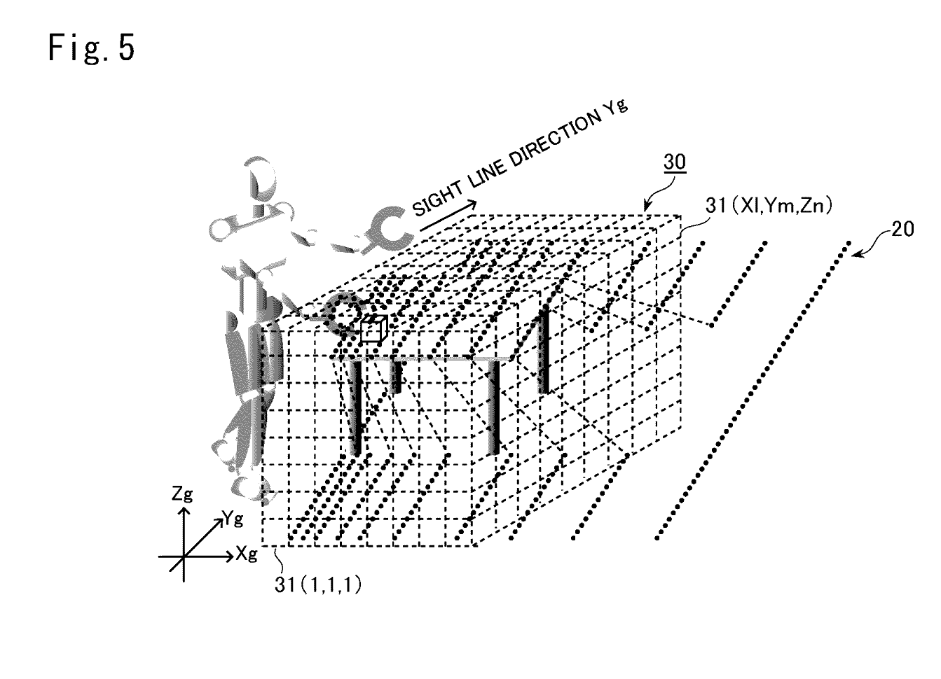

FIG. 5 is a diagram showing an example of the grid 30 (corresponding to the predetermined three-dimensional regions) arranged for the point group data 20 acquired by the robot 10. Referring to FIG. 5, the grid 30 is formed from a plurality of cells 31 (1, 1, 1) to (Xl, Ym, Zn) which are prescribed based on straight lines which are parallel to a direction Yg of a virtual sight line (hereinafter, to be referred to as a direction Yg of the sight line), straight lines which are parallel to a direction Xg orthogonal to the direction Yg of the sight line, and straight line which are parallel to a direction Zg orthogonal to both of the direction Yg and direction Xg of the sight line (each of l, m, n is a natural number equal to or more than 2). The direction Yg of the sight line of the grid 30 can be optionally set independently from the scan coordinate system (Xs, Ys, Zs) of the point group data 20. For example, the direction Yg of the sight line can be specified based on an instruction from the remote control terminal. It is possible to set the direction Yg of the sight line regardless of the direction of the head of the robot. Also, it is desirable that the direction of the grid 30 (the direction Yg of the sight line), the size of the cell 31, the number of cells, the position of the cell, or the size of the whole grid 30 are set by the remote control terminal 101. However, they may be previously set in the robot 10.

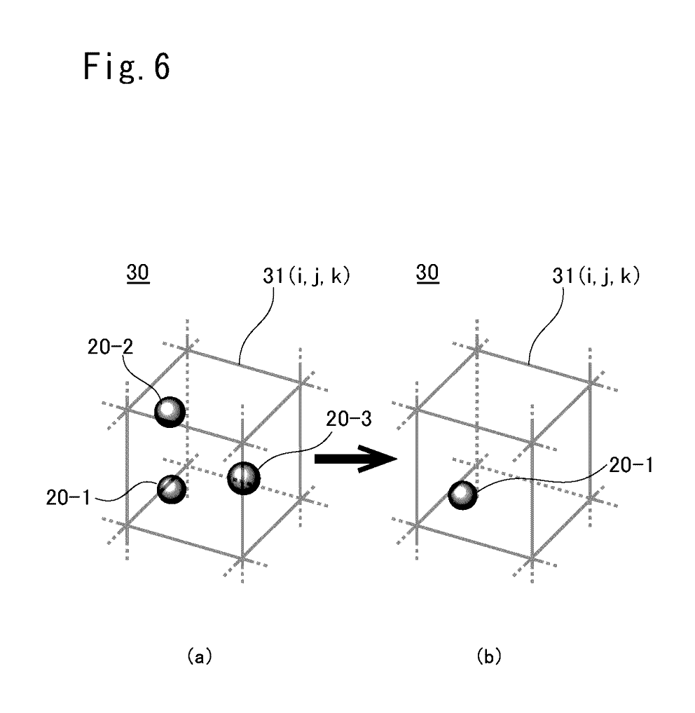

The robot 10 reduces a data quantity of the point group data 20 as the transmission object data with the filtering using the grid 30, and transmits the point group data 20 after the data quantity reduction to the remote control terminal 101. For example, the robot 10 (the data selecting section 12) restricts the number of point group data in the cell 31 to a predetermined number, and excludes a part of the point group data 20, which exceeds the predetermined number, or sets the priority of the transmission to a low level. Thus, the number of data to be transmitted of the plurality of closed point group data 20 can be restricted to the predetermined number or below. FIG. 6 is a diagram showing an example of the method of reducing the transmission data by using the grid 30. Referring to FIG. 6, a method of reducing the transmission data when an upper limit of the number of the point group data which is selected (registered) as the transmission data in the cell 31 is one will be described. As shown in (a) of FIG. 6, when three point group data 20-1, 20-2, and 20-3 are contained in a the virtual cell 31 (i, j, k), the data selecting section 12 selects (registers) only the point group data 20-1 as the point group data of the transmission object data, by excluding (not registering) the other point group data 20-2 and 20-3 from the transmission object data, as shown in (b) of FIG. 6 (1≦i≦l, 1≦j≦m, 1≦k≦m). When the size of the cell 31 is 1 cm³, for example, it is possible to select one of the plurality of point group data in the 1-cm cube as the transmission object data, and to exclude the remaining point group data from the transmission object data.

Note that the point group data 20-2 and 20-3 excluded from the transmission object data may be selected (registered) as data to be transmitted to the remote control terminal 101 after the transmission of the selected point group data 20-1. In this case, it is possible to transmit the point group data 20 of a large data quantity to the remote control terminal 101 by dividing for every predetermined data quantity.

An order which is selected (registered) as the transmission object data in the cell 31 can be optionally set. For example, the order may be selected based on the scan order of the three-dimensional sensor 2. In this case, the point group data 20 on the side of the upper stream in the scan direction of the three-dimensional sensor 2 in the cell 31 may be selected with a higher priority as the transmission object data. Specifically, the measurement is carried out in order of the point group data 20-1, 20-2, and 20-3, and when the upper limit of the transmission object data is 2, the point group data 20-1 and 20-2 are selected as the transmission object data.

As mentioned above, in the data transmission system 100, it is possible to reduce a data quantity of data to be transmitted to the remote control terminal 101 by using the grid 30 having the direction Yg as the reference. Note that the shape of the grid (cell 31) is not limited to a cube or a rectangular parallelepiped and may be a polyhedron. Also, the size of the cell 31 is not uniform over the grid 30 but may be different depending on the place. The size of the cell 31 can be changed by applying the Octree Method to the cell 31 in a predetermined region. In this case, the cell size can be set to be small near the edge of the measurement object and to be large apart from the edge. Or, to be described later, the size of the cell 31 in a specified region and the neighborhood region of the important point may be made smaller than another cell 31. Moreover, it is desirable that the grid 30 is arranged based on the direction Yg of the sight line, but it may be arranged based on another direction.

### First Embodiment

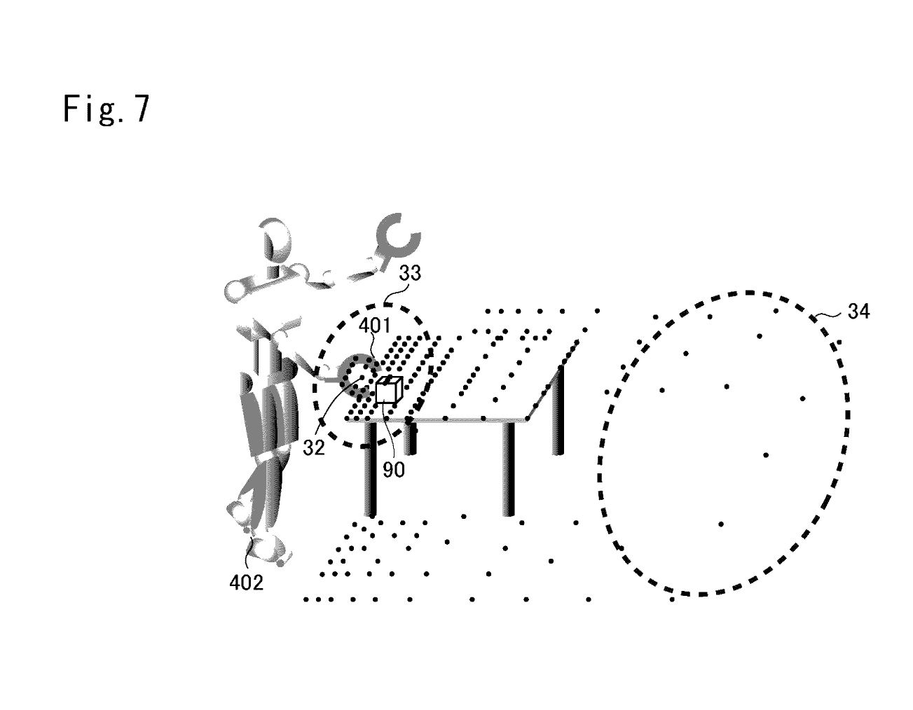

Referring to FIG. 7 to FIG. 14, the method of reducing transmission data in the data transmission system 100 according to a first embodiment will be described. In the first embodiment, a point group data transmission rate in the cell 31 is changed based on the position of the cell 31. That is, a region where a large number of the point group data 20 are decimated and a region where a small number of the point group data 20 are decimated are set depending on the position of the cell 31. As a result, it is possible to display an important region, which influences the remote control operation, in detail while reducing the data transmission quantity. Here, the transmission rate of the point group data 20 in the cell 31 means a rate of a data quantity of the selected data (not being always the point group data) as the transmission object data in a unit volume of the cell 31 to a data quantity of the point group data in the unit volume of the cell 31. In other words, the transmission rate indicates a value obtained by normalizing based on the cell size (cell volume), a rate of a data quantity of the transmission data to a total data quantity of the point group data in the cell 31.

FIG. 7 is a diagram showing an example of the method of reducing transmission data according to the first embodiment. Referring to FIG. 7, in the present embodiment, the transmission rate of a region 33 as the range having the predetermined distance from a important point 32 (to be referred to as a first region) is set to be larger than that of a region 34 (to be referred to as a second region). In order to improve the operation precision, it is desirable that an optional point (or, a point in the neighborhood) of the end effector 401 (the distal end) or the end effector 402 (the foot tip) is set as the important point 32 which determines the region 33 having a large transmission rate of the transmission data. For example, it becomes possible to transmit to the remote control terminal 101, a detailed situation of the peripheral region of the target object 90 held or planned to be held by the robot 10 or the peripheral region of the end effector 401, by setting predetermined position coordinates in the end effector 401 of the arm section 4 to the important point 32. Or, by setting predetermined coordinates of the end effector 402 of the leg section 3 to the important point 32, it becomes possible to instruct the walking control of the robot 10 in detail. Also, as for the other region, it becomes possible to reduce a total quantity of transmission data by setting a transmission rate small.

The region 33 may have any shape if the region is determined based on the important point 32, and it is desirable that the region 33 is determined to have a predetermined distance from the important point 32. The region 34 in which the transmission rate of the transmission data is made small is set to a part except for the region 33 of the region in which the point group data 20 are distributed. Also, the region 34 may be set for the transmission rate of the transmission data to be made small step-by-step according to the distance from the important point 32. For example, the region in which the point group data 20 are distributed is divided into a plurality of regions, and the transmission rate of the transmission data may be made small according to (for example, in proportional to) the distance from the important point 32 to each of the divided regions. Moreover, a plurality of the regions 33 and 34 may be set. In such a case, an upper limit of the number of the point group data registered as the transmission data (the transmission object point group data) and the transmission rate can be optionally set to the cell 31 contained in each of the plurality of regions. Also, conditions for determining the regions 33 and 34 can be optionally set without restricting to the conditions in the above-mentioned method. For example, a predetermined condition may be determined such that the region 33 prescribed by a plurality of cells 31 which meet the predetermined condition, and the region 34 prescribed by a plurality of other cells 31 which do not meet the predetermined condition are set. Note that the predetermined condition may be selected based on the position coordinates of the cells 31 or an array of the cells and so on. Each of the important point 32, the region 33, and the region 34 can be specified from the remote control terminal 101. Also, the robot 10 may calculate the region 33 and the region 34 automatically based on the important point 32 specified by the remote control terminal 101. In this case, it is desirable that parameters such as a distance from the important point 32 to determine the regions 33 and 34 are previously set to the robot 10.

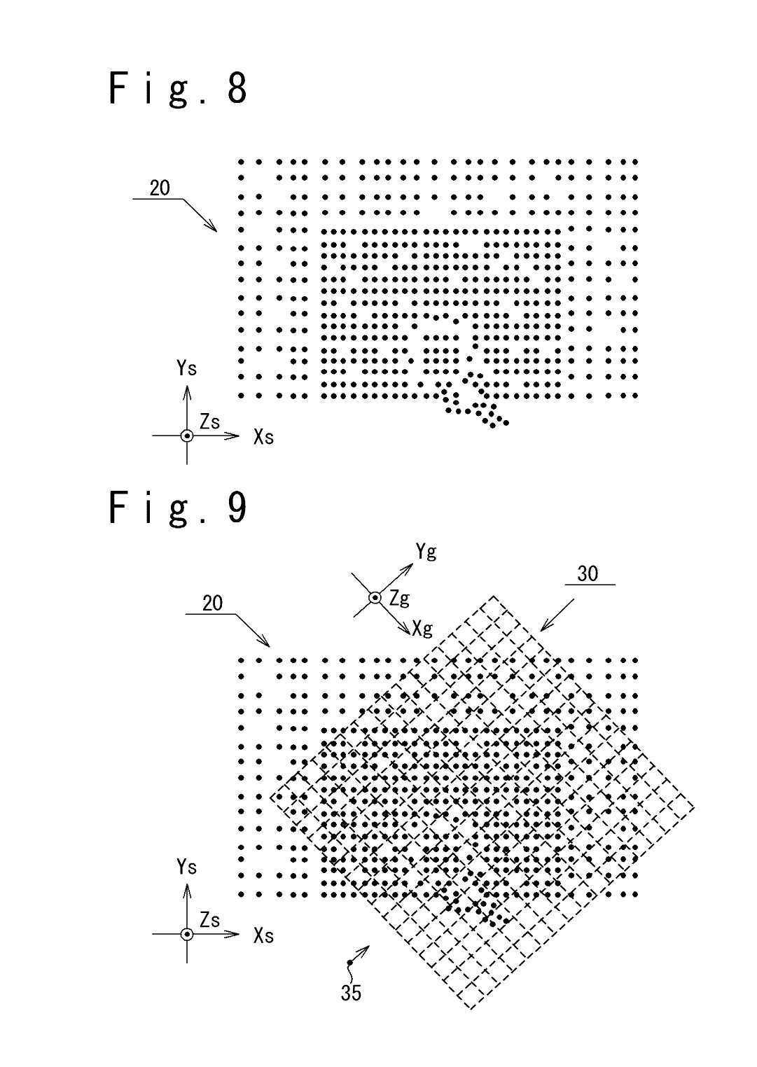

The transmission rate of the point group data 20 which is set for each of the regions 33 and 34 can be changed by changing the size of the cell 31 or by changing the upper limit of the point group data which are registered into the cell 31 as the transmission object data. Referring to FIG. 8 to FIG. 14, a change example of the transmission rate of the transmission data by using the grid 30 will be described. Actually, the point group data 20 shown in the three-dimensional coordinates are excluded from the transmission object data. However, the point group data 20 and the grid 30 are shown 2-dimensionally for simplification of the description. FIG. 8 is a diagram showing an example of the point group data 20 measured by the robot 10.

First, as shown in FIG. 9, the grid 30 is arranged in a virtual space in which the point group data 20 are distributed. At this time, it is desirable that a virtual view point 35, an arrangement position of the grid 30 or its shape, a direction Yg of the sight line, sizes (the grid division sizes) of the cells 31 and so on are specified by the remote control terminal 101. Note that any of the virtual view point 35, the arrangement position of the grid 30 or the shape, the direction Yg of the sight line, the size of each cell 31 (the grid division size), the number, the arrangement may be previously set in the robot 10, and the grid 30 may be arranged using the above setting.

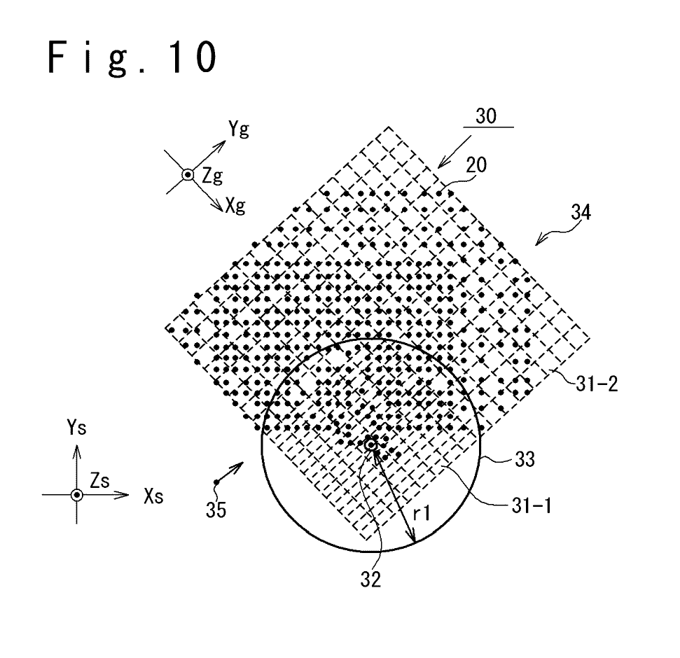

In an example shown in FIG. 10, a grid division size (the size of the cell 31) of the region 33 around the important point 32 is set to be smaller than a grid division size (the size of the cell 31) of another region 34 in the grid 30 shown in FIG. 9. For example, the size of the cell 31-1 in the region 33 which has a radius r1 around the important point 32 as a center is set to a half of the size of the cell 31-2 in the other region 34. When the upper limit of the number of point group data 20 in all the cells 31 is limited to a same value (e.g. one), the transmission rate of the point group data 20 in the region 33 with a small cell size is larger than that of the other region 34. In other words, the point group data 20 which is excluded from the transmission object data, in the region 34 with a large cell size increases more than the region 33. Thus, a data density of the point group data 20 as the transmission object data in the region 33 is higher than that of the transmission object data in the other region 34.

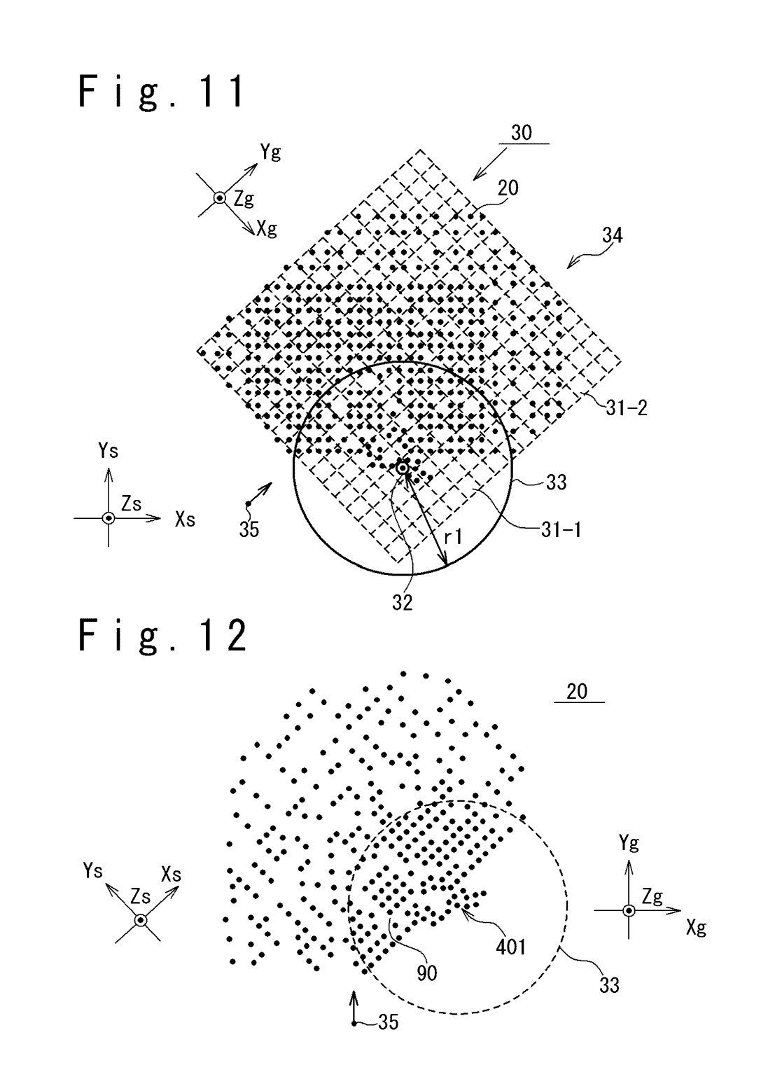

Also, as shown in FIG. 11, by not changing the size of the cell 31 in the region 33 and region 34 (in case of equal size) but changing the upper limit of the number of data in the cell 31 based on the region (place), the transmission rate of the point group data may be changed. In FIG. 11, for example, the transmission rate of the point group data 20 of the cell 31-1 in the region 33 which has the radius r1 around the important point 32 as the center is made 100% (no upper limit of the number of point group data as the transmission object data), the upper limit of the cell 31-2 in the other region 34 can be made one. Even by this method, the transmission rate of the point group data 20 in the region 33 can be made larger than the other region 34. The data density of the point group data 20 as the transmission rate in the region 33 can be made higher than the data density of the transmission object data in the other region 34.

Note that as shown in FIG. 10 and FIG. 11, it is desirable that the point group data 20 in the region where the grid 30 is not arranged are fully excluded from the transmission object data (or, the priority of the transmission order is set low).

As mentioned above, in the data transmission system 100 of the present embodiment, because the upper limit of the number of point group data in the cell 31 is determined for every region 33 or 34, a data communication quantity can be reduced while optionally changing the sparse and dense of the point group data 20 in the predetermined region (e.g. the region 33 or region 34).

FIG. 12 is a diagram showing the point group data 20 selected as the transmission object data by the method shown in FIG. 11. As shown in FIG. 12, because the density difference occurs in the transmission data in the regions 33 and 34, the remote control terminal 101 can acquire the detailed image of the region around the end effector, and a simplified image of the other region.

In an example shown in FIG. 10 to FIG. 12, the method of increasing the data transmission rate of the region 33 determined based on the important point 32 has been described. However, the present invention is not limited to this, and the upper limit of the number of and the transmission rate of the point group data as the transmission object data in the cell 31 may be determined based on the virtual viewpoint 35 and the direction Yg of the sight line.

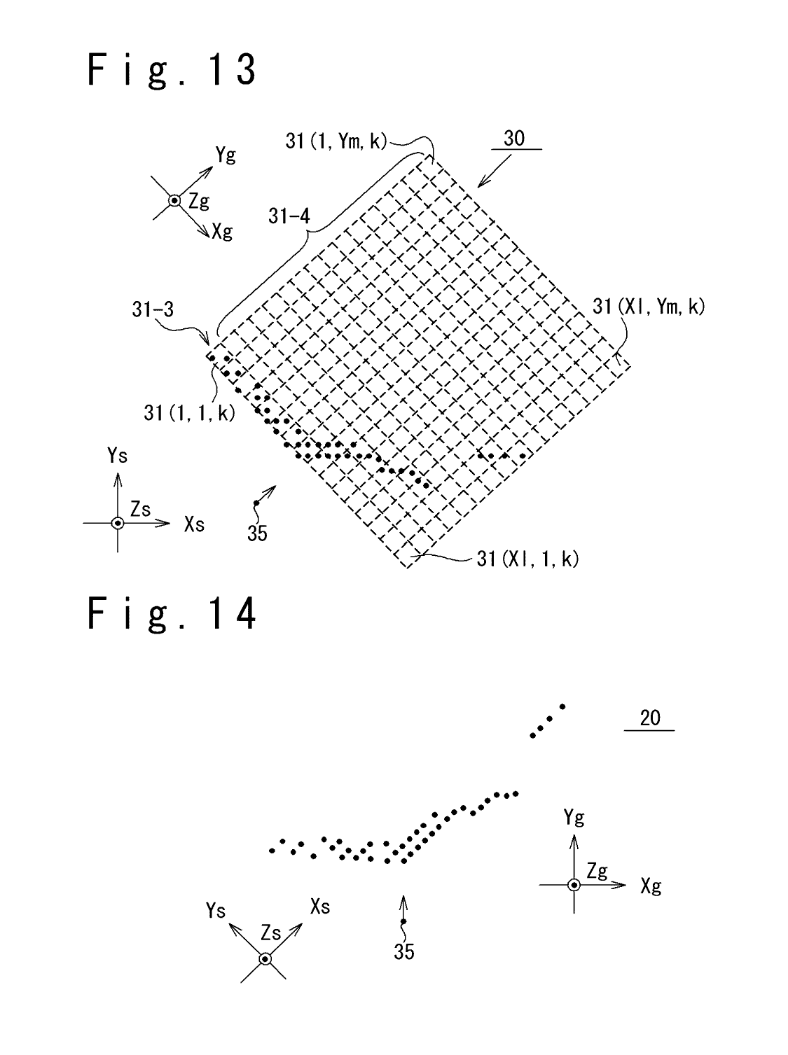

Hereinafter, referring to FIG. 9, FIG. 13 and FIG. 14, a specific instance will be described of the method of selecting the transmission object data based on the virtual viewpoint 35 or the direction Yg of the sight line.

First, as shown in FIG. 9, the grid 30 is arranged in the virtual space on which the point group data 20 are distributed. At this time, the virtual viewpoint 35, the arrangement position and shape of the grid 30, the direction Yg of the sight line, the size (the grid division size) of the cell 31, the number of cells or the positions of the cells are specified by the remote control terminal 101.

Referring to FIG. 13, only the point group data 20 in the visible cells 31-3 (to be also referred to as a first region) are registered as the transmission object data in view of the direction Yg of the sight line from the virtual viewpoint 35. The point group data in the other cells 31-4 (to be also referred to as a second region) are excluded from the transmission object data. In detail, in a cell sequence (the cell 31 (i, 1, k) to the cell 31 (i, Ym, k)) in the direction Yg of the sight line, when the cell 31 which is the nearest to the side of the virtual viewpoint 35, of the cells 31 which include the point group data 20 is the h^{th} cell 31-3 (i, h, k) in the direction Yg of the sight line, the point group data 20 within the cell 31-3 (i, h, k) are registered as the transmission object data, and the point group data 20 of the other cell 31-4 (i, h+1, k) to the cell 31-4 (i, Ym, k) are excluded from the transmission object data (here, 1≦h≦Ym−1). Also, when the cell 31-3 which is the nearest to the virtual viewpoint 35, of the cells 31 which include the point group data 20 is the Ym^{th} cell 31 in the cell sequence (the cell 31 (i, 1, k) to the cell 31 (i, Ym, k)) in the direction Yg of the sight line, the point group data 20 of the cell 31-3 (i, Ym, k) is registered as the transmission object data.

FIG. 14 is a diagram showing the point group data 20 in which the transmission data quantity is reduced by the method shown in FIG. 13 and which is selected as the transmission object data. As shown in FIG. 14, only the visible surface shape is the transmission object data to the remote control terminal 101 upon viewing in the direction Yg of the sight line from the virtual viewpoint 35, and the point group data 20 on the rear side upon viewing in the direction Yg of the sight line are excluded from the transmission object data.

In the present embodiment, because only the visible surface shape upon viewing in the direction Yg of the sight line from the virtual viewpoint 35 is transmitted to the remote control terminal 101, the remote control terminal 101 can display the visible image in which the point group data 20 are omitted which overlaps in the direction of the depth, as shown in FIG. 14. Also, because all of the point group data 20 which overlap in the direction of the depth are excluded from the transmission data, the data communication quantity can be more reduced, compared with the method shown in FIG. 10 and FIG. 11. In the present embodiment, all of the point group data 20 of the cell 31-4 on the rear side upon viewing from the virtual viewpoint 35 are excluded from the transmission object data. However, the present invention is not limited to this and a predetermined number of point group data 20 of the point group data 20 in the cell 31-4 may be registered as the transmission object data. In other words, in the present embodiment, the upper limit of the number of the point group data as the transmission object data in the predetermined region (the cell 31-4) is set to 0, and this upper limit can be optionally set. In this case, it is desirable that the transmission data is selected by the above method. Moreover, in order to reduce the transmission data more, the transmission data may be selected to the cell 31-3 by the above method. The upper limit of the number of the point group data 20 of the transmission object data in the cell 31-3 is set to be more than the upper limit of the number of the point group data 20 of the transmission object data in the cell 31-4.

The method of setting the region 34 or the cell 31-4 in which the transmission rate of the point group data small is made small, or the region 33 or the cell 31-3 in which the transmission rate is made large (containing case of not reducing) are not limited to the above methods. The method may be determined based on the predetermined condition to prescribe the cell position. For example, a region far by a predetermined distance or more from the virtual viewpoint 35 in the direction Yg of the sight line may be set as the region 34 and a near region may be set as the region 33. Or, the cell 31 having a large transmission rate and the cell 31 having a small transmission rate may be set based on a condition indicating the cell position (the coordinates). As an example, even numbered cells in the Xg coordinate direction, even numbered cells in the Yg coordinate direction, or even numbered cells 31 in the Zg coordinate direction are set as the cells 31-3 having large transmission rates. Also, odd numbered cells in the Xg coordinate direction, odd numbered cells in the Yg coordinate direction, or odd numbered cells 31 in the Zg coordinate direction are set as the cells 31-4 having small transmission rates. The predetermined distance to determine the regions 33 and 34 or the condition to determine the cells 31-3 and 31-4 may be previously set to the robot 10, and they may be specified from the remote control terminal 101.

### Second Embodiment

The robot 10 of the second embodiment determines the data to be transmitted to the remote control terminal 101 (the shape reproduction data to be described later) based on the shape of the measurement object estimated from the point group data 20. The displaying section 202 of the remote control terminal 101 in the second embodiment generates the point group data based on the data transmitted from the robot 10, and displays the surface shape of the measurement object by using the point group data. Hereinafter, the method of reducing the transmission data in the second embodiment of the data transmission system 100 will be described.

The data transmission system 100 of the present embodiment changes a reduction rate of the transmission data based on a “local shape of the measurement object”. Here, the “local shape of the measurement object” is possible to be classified based on the magnitudes of three eigenvalues which are obtained by main component analysis to the point group data in a predetermined range. When the eigenvalues are d1, d2, and d3 in larger order, the local shape of the measurement object can be classified to any of a pattern 1 to a pattern 5.

d1≈d2≈d3≈0: A point structure having 0-dimensional spread—pattern 1,

d1>>d2≈d3≈0: A linear structure having 1-dimensional spread—pattern 2,

d1>d2>>d3≈0: A planar structure having 2-dimensional spread—pattern 3,

d1>d2>d3>>0: A steric structure having 3-dimensional spread—pattern 4,

The others: Pattern 5.

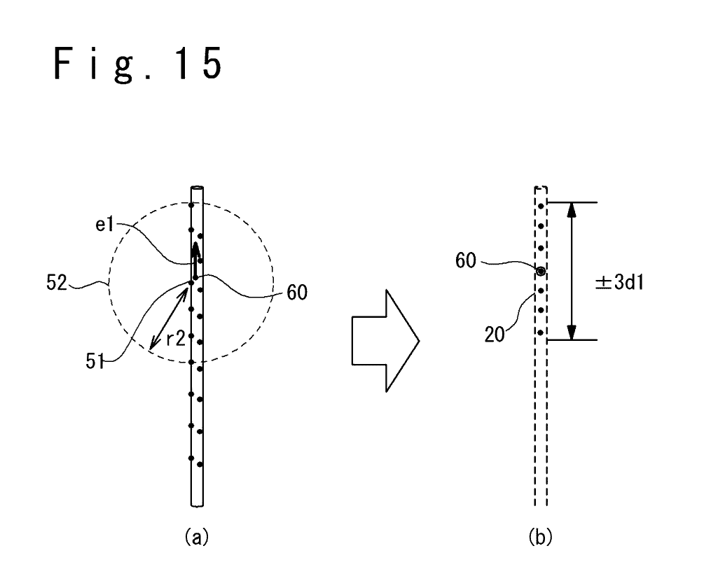

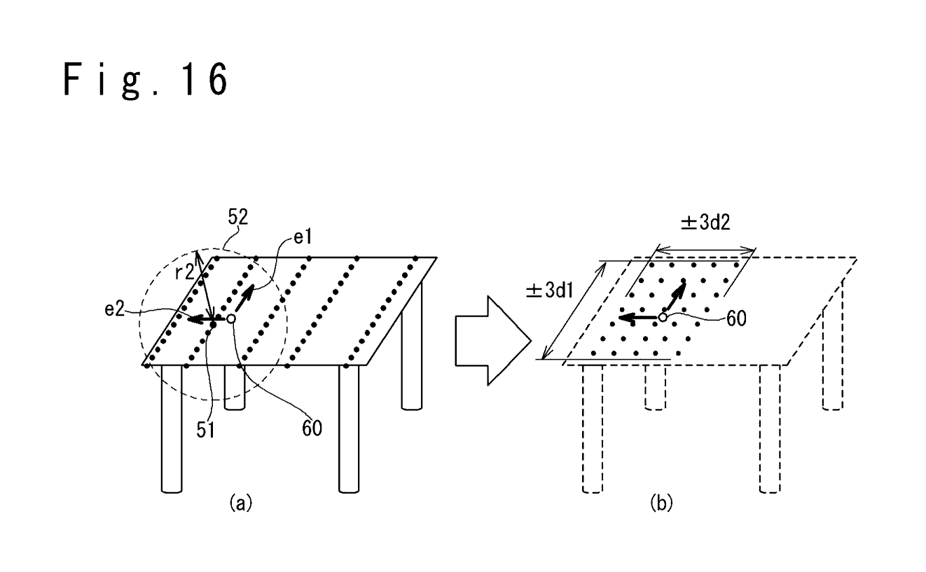

Referring to FIG. 15 to FIG. 17, the method of classifying the local shape of the measurement object and the method of reducing the transmission data quantity will be described in detail.

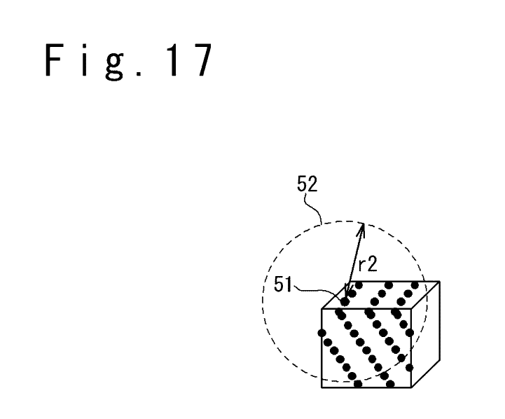

Referring to (a) of FIG. 15, (a) of FIG. 16, and FIG. 17, the data selecting section 12 of the robot 10 sets one of the measured point group data 20 as a reference point 51, and sets a range according to the reference point 51 as an analysis region 52. For example, the analysis region 52 is a spherical region having a radius r2 around the reference point 51 as a center. The reference point 51 may be randomly determined. Also, it is desirable that a distance from a reference point 51 which determines the analysis region 52 (e.g. radius r2) is set based on a fixation value. The distance from the reference point 51 which determines the analysis region 52 (e.g. radius r2) is set to, for example, ½ of the largest eigenvalue. When more than one reference points 51 are set, it is desirable that the interval between neighbor reference points 51 is set to such a length that the analysis regions 52 do not overlap (e.g. equal to or more than the radius r2).

The data selecting section 12 carries out the main component analysis to the point group data 20 (the position coordinates indicated by the point group data 20) in the analysis region 52, and determines the eigenvalues d1, d2, and d3 and peculiar vectors e1, e2, and e3 corresponding to these. In detail, the covariance matrix determined from the position coordinates indicated by the point group data 20 in analysis region 52 is subjected to eigenvalue dissolution, and the eigenvalues d1, d2, and d3 and the peculiar vector e1, e2, and e3 corresponding to them are determined. Here, the data selecting section 12 classifies the shape in the analysis region 52 into either of pattern 1 to pattern 5 based on the magnitudes of the eigenvalues d1, d2, and d3. The data selecting section 12 selects the data to be transmitted according to the classified pattern. At this time, when classified to pattern 2 or pattern 3, the data selecting section 12 transmits the analysis result to the analysis region 52 to the remote control terminal 101 as the shape reproduction data in place of the point group data 20 in the analysis region 52. The remote control terminal 101 arranges the point group data which is distributed in the range of the shape indicated by the shape reproduction data in a predetermined interval based on the shape reproduction data, and produces and displays a measurement object shape image.

When the point group data 20 centers approximately on one point, that is, when the point group data 20 shows the structure having 0-dimensional spread, an eigenvalue is classified into pattern 1 of d1≈d2≈d3≈0. That is, when all of the eigenvalues d1, d2, and d3 are smaller than a first predetermined threshold value (in other words, when all of the eigenvalues d1, d2, and d3 can be approximated to 0 (containing 0)), the eigenvalues are classified into pattern 1. The data selecting section 12 excludes all of the point group data 20 in the analysis region 52 classified into pattern 1 from the transmission object data (the transmission rate is 0%). That is, the point group data 20 in the analysis region 52 classified into pattern 1 are not completely transmitted to the remote control terminal 101. As for this region, because it is possible to determine that there are not a landform and an obstacle which influence the action of the robot 10, it is not necessary to transmit the point group data 20 to the remote control terminal 101.

When the point group data 20 shows the structure having 1-dimensional spread as shown in (a) of FIG. 15, the eigenvalues are classified into pattern 2 of d1>>d2≈d3≈0. That is, the eigenvalue d2 and the eigenvalue d3 are smaller than a second predetermined threshold value (the eigenvalue d2 and the eigenvalue d3 can be approximated to 0 (containing 0)), and when the value of the eigenvalue d1 is larger than a third predetermined threshold value (when the third threshold value is equal to or is larger than a second threshold value), the eigenvalues are classified into pattern 2. The data selecting section 12 selects the shape reproduction data as the transmission object data to the remote control terminal 101 in place of the point group data 20 in the analysis region 52 classified as pattern 2. For example, referring to (a) of FIG. 15, average coordinates 60 (the three-dimensional coordinates Aa) of the point group data 20 (the three-dimensional coordinates A1 to Ai) in the analysis region 52 classified as pattern 2, the peculiar vector e1 corresponding to the eigenvalue d1, and the eigenvalue d1 are transmitted to the remote control terminal 101 as the shape reproduction data. Here, the average coordinates 60 mean central coordinates of the distribution range of the point group data 20. Also, the peculiar vector e1 means a direction of spread of the distribution range of the point group data 20. The eigenvalue d1 means the size of the distribution range of the point group data 20 in the direction of the peculiar vector e1. Because the shape reproduction data of a small data quantity is transmitted for the range classified into pattern 2 in place of the point group data, the data communication quantity can be greatly reduced (transmission rate is small).

Referring to (b) of FIG. 15, the displaying section 202 of the remote control terminal 101 sets a range where spreads for the size determined based on the eigenvalue d1, to the direction of the peculiar vector e1 around the average coordinates 60 of a center, as the distribution range of the point group data, and generates and displays the point group data arranged in the predetermined interval in the distribution range. For example, the displaying section 202 displays the point group data arranged in a predetermined interval in the distribution range of the point group data as a linear range of ±3 times of the eigenvalue d1 (±3d1·peculiar vector e1) from the average coordinates 60 to the direction of the peculiar vector e1. The reproduced, interval of the point group data may be previously set or specified by the input unit 103 which the user operates. Also, the displaying section 202 generates and displays the surface shape of the measurement object based on the generated point group data.

When the point group data 20 shows the structure having a 2-dimensional spread as shown in (a) of FIG. 16, the eigenvalues are classified into pattern 3 of d1>d2>>d3≈0. That is, only the eigenvalue d3 is smaller than a fourth predetermined threshold value (the eigenvalue d3 can be approximated to 0 (containing 0)). The values of the eigenvalue d1 and the eigenvalue d2 are larger than a fifth threshold value (the fifth threshold value is equal to or is larger than the fourth threshold value). Moreover, when the value of the eigenvalue d1 is larger than the value of the eigenvalue d2, in addition to the above conditions, the eigenvalues are classified into pattern 3. The data selecting section 12 transmits the shape reproduction data to the remote control terminal 101 in place of the point group data 20 in the analysis region 52 classified as pattern 3. For example, referring to (a) of FIG. 16, the average coordinates 60 of the point group data 20 (the three-dimensional coordinates A1 to Ai) in the analysis region 52 classified as pattern 3 (the three-dimensional coordinates Aa), the peculiar vector e1 corresponding to the eigenvalue d1, the peculiar vector e2 corresponding to the eigenvalue d2, the eigenvalue d1 and the eigenvalue d2 are transmitted to the remote control terminal 101 as the shape reproduction data. Here, the average coordinates 60 mean central coordinates in the distribution range of the point group data 20. Also, the peculiar vectors e1 and e2 mean the directions of the spread of the distribution range of the point group data 20. The eigenvalue d1 means the size of the distribution range of the point group data 20 in the direction of the peculiar vector e1. The eigenvalue d2 means the size of the distribution range of the point group data 20 in the direction of the peculiar vector e2. As for the region classified into pattern 3, because the shape reproduction data of a small data quantity is transmitted in place of the point group data, the data communication quantity can be mainly reduced (transmission rate is small).

Referring to (b) of FIG. 16, the displaying section 202 of the remote control terminal 101 sets as the distribution range of the point group data, a region which spreads in the direction of the peculiar vector e1 by the size based on the eigenvalue d1 with respect to the average coordinates 60 as the center, and which spreads in the direction of the peculiar vector e2 by the size based on eigenvalue d2. Also, the displaying section 202 generates and displays the point group data arranged in a predetermined interval in the distribution range. For example, the displaying section 202 sets as the distribution range of the point group data, a plane range surrounded by a range of 3 times of the eigenvalue d1 (±3d1·peculiar vector e1) from the average coordinates 60 in the direction of the peculiar vector e1 and a range of 3 times of the eigenvalue d2 (±3d2·peculiar vector e2) from the average coordinates 60 in the direction of the peculiar vector e2, and the displaying section 202 arranges and displays the point group data in a predetermined interval in the range. The interval of the point group data may be previously set and specified by the input unit 103 which the user operates. Also, the displaying section 202 may generate and display the surface shape of the measurement object based on the generated point group data.

Referring to FIG. 17, when the point group data 20 shows the structure having 3-dimensional spread, the eigenvalues are classified into pattern 4 of d1>d2>d3>>0. That is, all of the eigenvalues d1, d2, and d3 are larger than a sixth predetermined threshold value, compared with “0”. The eigenvalue d2 is larger than the eigenvalue d3. When the eigenvalue d1 is larger than the eigenvalue d2, in addition to the above conditions, the eigenvalues are classified into pattern 4. As for the point group data 20 in the analysis region 52 classified into pattern 4, because the user operating the remote control terminal 101 has a strong request to confirm a solid shape in detail, it is desirable to completely select as the transmission object data (transmission rate of 100%). Or, as for the point group data 20 in the analysis region 52 classified into pattern 4, the data selecting method using the above-mentioned grid 30 may be adopted.

When the eigenvalues d1, d2, and d3 show values corresponding to neither of pattern 1 to pattern 4, the eigenvalues d1, d2, and d3 are classified into pattern 5. It is desirable that regarding the point group data 20 in a region (not shown) classified into pattern 5, the selection of the transmission data is carried out by the data selecting method using the above-mentioned grid 30. Or, the point group data 20 of the region classified into pattern 5 may be completely excluded from the transmission object data (transmission rate of 0%).

Note that the first to sixth threshold values used to compare the eigenvalues in the pattern determination may be set optionally according to the measurement precision of the sensor and acquisition of the point group data. For example, the first to sixth threshold values used for the pattern determination are optionally set based on the measurement precision of the sensor. Specifically, when the measurement deviation is ±1 cm, 3 times of standard deviation (3 σ) is ±1 cm and the eigenvalue d3 (the square of σ) is 1/9. In this case, when detecting unevenness on the plane in consideration of a measurement deviation, a criterion (the fourth threshold value) of whether or not the eigenvalue d3 is approximated 0 needs to be set to a value larger than 1/9. For example, by setting the fourth threshold value to ⅕ in the sensor having the measurement deviation of ±1 cm, it is determined that the eigenvalue d3 can be approximated to 0 in case of being smaller than ⅕, and it is possible to determine a plane shape. Also, the optional measurement precision can be realized by optionally setting the first to sixth threshold values used for the pattern determination. For example, a reference value (e.g. the fourth threshold value) used to determine whether or not the eigenvalue is approximated to 0 is set to be a larger value in case of measurement in a meter unit (the coarse measurement), compared with a case (the precise measurement) of measurement of unevenness of the plane (solid state) in a millimeter unit.

When determined to be pattern 2 or pattern 3, the form of the shape reproduction data is not limited to the above-mentioned form if a 1-dimensional or 2-dimensional shape can be reproduced in the remote control terminal 101. For example, when determined to be pattern 2 (when determined as the 1-dimensional shape), at least two sets of the point group data 20 which can define a linearity are selected as the transmission object data (for example, two points separated by the eigenvalue d1 in the direction of the peculiar vector e1). Or, when determined to be pattern 3 (when determined as the 2-dimensional shape), at least three sets of the point group data 20 which can define a plane shape are selected as the transmission object data (for example, two points separated by the eigenvalue d1 in the direction of the peculiar vector e1, and one point separated by the eigenvalue d2 in the direction of the peculiar vector e2 in the one of the above two points). In this case, too, the traffic between the robot 10 and the remote control terminal 101 can be greatly reduced.

In the present embodiment, the transmission data in a region is selected according to the pattern classified for every region, and an upper limit of the data quantity is determined. For example, when the shape reproduction data is set as the transmission object data to some region, the data quantity to the region is determined based on the data quantity of the shape reproduction data.

As mentioned above, according to the data transmission method in the second embodiment, the shape reproduction data for which it is possible to reproduce the surface shape of the measurement object in the remote control terminal 101 is selected based on a prediction shape of the measurement object and is transmitted to the remote control terminal 101. Because the shape reproduction data is less in the data quantity than the point group data 20, the data communication quantity can be reduced, compared with the case of transmitting the point group data 20. Also, because the distribution of the point group data and the shape of the object are reproduced based on the data according to the surface shape of the measurement object, the situation around the robot 10 can be grasped in the range where there is not an influence in the operability to the robot 10.

Next, the method of transmitting the point group data 20 or data to reproduce the surface shape of the measurement object to the remote control terminal 101 from the robot 10 will be described.

The robot 10 may transmit the data excluded from the selection object to the remote control terminal 101 in addition to the data selected as the transmission object data by the above-mentioned selecting method. In this case, it is desirable that the robot 10 transmits the data selected as the transmission object data before the data excluded from the selection object. That is, it is desirable that the transmission order of the data to be transmitted to the remote control terminal 101 is set by the above-mentioned method of selecting the transmission object data. In detail, first, the data selected as the transmission object data from among the measured point group data 20 is transmitted with the highest priority, and then the other data (the data excluded from the transmission object data) are transmitted. Also, the transmission order may be determined such that the above-mentioned selection processing is further carried out to the point group data excluded from the transmission object data. Thus, the point group data 20 or shape reproduction data having a high importance is first transmitted to the remote control terminal 101, and then the data having a low importance is transmitted. The user who operates the remote control terminal 101 can obtain the important data to operate the robot 10 (for example, a situation around the distal end) at an earlier step after the data transmission from the robot 10 is started, and then the measurement object can be grasped by the data having a low importance.

Also, the robot 10 may transmit the point group data 20 as the transmission object data in the region 33 having a large transmission rate of the point group data 20 or the cell 31-3 with the highest priority, and then may transmit the point group data 20 of the transmission object data in another region 34 or the cell 31-4. That is, it is desirable that the transmission order to the remote control terminal 101 is set based on the transmission rate of the point group data 20. At this time, the point group data 20 excluded from the transmission object data is transmitted after the point group data 20 set as the transmission object data in the regions 33 and 34 or the cell 31-3 and 31-4 are transmitted. In this case, the user of the remote control terminal 101 can visibly know the surface shape image in the important region (for example, a distal end and on the front side in the direction of the sight line) at the earlier step, and then the whole measurement object can be grasped. Note that when the transmission order of the point group data 20 in the regions 33 and 34 is set, all the point group data 20 in the regions 33 and 34 may be transmitted.

Moreover, the robot 10 may set the transmission order of the point group data 20 based on the condition indicating the cell position (e.g. the cell coordinates). For example, the point group data 20 in cells numbered as multiple of 4 in the Xg coordinate direction, cells numbered as multiple of 4 in the Yg coordinate direction, or cells numbered as multiple of 4 in the Zg coordinate direction are transmitted with the highest priority. The point group data 20 in the cells numbered as multiple of 2 in the Xg coordinate direction (excluding multiple of 4), the cells numbered as multiple of 2 in the Yg coordinate direction (excluding multiple of 4), or the cells numbered as multiple of 2 (excluding multiple of 4) in the Zg coordinate direction are next transmitted. Next, the point group data 20 in the other cells are transmitted last. In this case, the point group data 20 (the point group data in the cell for every predetermined interval) are first transmitted to form an image with a coarse spatial resolution. Next, the point group data 20 (the point group data 20 in the cells between the cell 31 from which the point group data has been transmitted and the other cell 31 from which the point group data has been transmitted) are transmitted to form an image with a fine spatial resolution. The user of the remote control terminal 101 can confirm the coarse shape of the measurement object at the step that receives data with the coarse spatial resolution, and can grasp the detailed situation with the elapse of time (the reception of sequentially transmitted data).

As mentioned above, according to the data transmission system 100 according to the embodiments, the minimum data which is necessary to operate the robot 10 are transmitted with a priority, and it is possible to generate an image based on the data in the remote control terminal 101. Therefore, the user can grasp the situation around the robot in short time, even when the communication environment is bad or even when a transmission path with a small communication capacity is used. Thus, the time required for the robot operation can be shortened. Also, because the data is transmitted step-by-step, the user can grasp the more detailed situation with elapse of time.

The robot 10 is desirable to use the point group data 20 (hereinafter, to be referred to as high density data) with a high density measured with the three-dimensional sensor 2 for an autonomous operation, in addition to the point group data 20 (hereinafter, to be referred to as low density data) with a low density selected for the transmission. That is, the robot 10 is desirable that it can use a plurality of data of the point group data 20 with the low density and the high density according to the application. The human being can operate the robot 10 by referring to map data and the surface shape produced from the low density data (for example, the minimum interval of the point group data is about 1 cm). On the other hand, in the autonomous operation of the robot 10 (e.g. the autonomous traveling), the map data and the surface shape of the high precision become necessary in order to prevent from crashing and falling. Therefore, it is desirable that the robot 10 transmits the low density data for the remote operation, and uses the map data generated based on the high density data for the autonomous traveling. By using sparse and dense data in this way, it becomes possible to reduce the data transmission quantity while maintaining the precision of the autonomous control of the robot 10.

Also, because the human being has high recognizing ability of the difference of the color in addition to the difference of the shape, it is desirable that color data is added to the point group data which are used for the remote operation. Therefore, it is desirable that the robot 10 transmits the point group data 20 (Xs, Ys, Zs, R, G, B) added with the color data (RGB) or the color data (RGB) and the point group data (Xs, Ts, Zs) to the remote control terminal 101. On the other hand, in the autonomous control of the robot 10, because the control precision can be maintained only by the coordinate data, it is desirable to use the point group data (Xs, Ys, Zs) added with no color data (RGB) for the controls such as the autonomous traveling of the robot 10. That is, it is desirable that the robot 10 transmits data with the color data for the remote operation, and uses the map data generated based on the data without the color data for the autonomous traveling. By using the existence or non-existence of the color data in this way, it becomes possible to reduce the data transmission quantity while maintaining the precision of the autonomous control of the robot 10.

Moreover, it is desirable that the robot 10 controls a reduction rate of the transmission data based on the communication quality or the communication capacity in the communication with the remote control terminal 101. For example, the robot 10 sets the reduction quantity of the transmission data to be large when the communication speed is low, and sets the reduction quantity to be small when the communication speed is high. Or, when the traffic between the robot 10 and the remote control terminal 101 exceeds the communication capacity previously set, the reduction quantity of the transmission data is set to be large. Here, the communication quality shows the communication speed or the propagation environment (e.g. reception strength) in the transmission path between the robot 10 and the remote control terminal 101, and the communication quality is measured in the robot 10 or the remote control terminal 101. The robot 10 itself may measure the communication quality and carry out the setting or change of the transmission rate based on the measured result. However, from the viewpoint of the reducing and lightening of the processing load of the robot 10, it is desirable that the control for the measurement of the communication quality and the setting or change of the transmission rate to the robot 10 is carried out by the remote control terminal 101.

As mentioned above, according to the embodiment, the data of the surface shape of the measurement object can be efficiently selected and transmitted to the remote control terminal 101. Therefore, it becomes possible to remote-control the robot 10 in a small data communication quantity, even in the situation that the communication speed is low, the upper limit of communication capacity is small, or the communication quality is inferior. Also, because data about the shape which has an important influence on the remote operation is selected and transmitted early, the user can determine quickly, and the operation using the robot 10 can be completed in short time.

In the above, the embodiments of the present inventions have been described in detail. However, a specific configuration is not limited to the above embodiments and a modification or change in the range which does not deviate from the point of the present invention is contained in the present invention. The above-mentioned embodiments and examples can be combined with another embodiment and an example, in a range with no technical contradiction.

The present application is based on Japanese Patent Application No. JP 2014-74378 filed on Mar. 31, 2014, and claims the benefit of priority of the application. The disclosure thereof is incorporated herein by reference.

1. A data transmission apparatus comprising:
an actuator controlled in response to a control signal from a remote control terminal;
a three-dimensional sensor configured to acquire point group data showing three-dimensional coordinates of points;
a processing unit configured to select transmission object data based on the point group data; and
a communication section configured to transmit the transmission object data to the remote control terminal,
wherein the processing unit sets an upper limit of a data quantity of the transmission object data which belong to a predetermined three-dimensional region.

2. The data transmission apparatus according to claim 1, wherein the processing unit virtually arranges a three-dimensional grid having a plurality of cells in a region in which a plurality of the point group data are distributed, and selects the point group data of a number less than or equal to an upper limit and set to each of the plurality of cells as the transmission object data of the cell.

3. The data transmission apparatus according to claim 2, wherein the processing unit sets a transmission rate of the point group data to each cell such that the transmission rate of the point group data in a first region is larger than that of the point group data in a second region different from the first region, and
wherein the transmission rate is a value obtained by normalizing based on a size of each cell, a rate of a data quantity of the transmission object data in the cell to a data quantity of the point group data in the cell.

4. The data transmission apparatus according to claim 3, wherein the processing section sets an upper limit of a number of transmission object point group data in each cell such that the upper limit of the number of the transmission object point group data of the cell in the first region is larger than that of a number of the transmission object point group data of the cell in the second region.

5. The data transmission apparatus according to claim 3, wherein the size of each cell in the first region is smaller than that of each cell in the second region,
wherein the processing unit sets the upper limit of the number of the transmission object point group data to each cell such that the upper limit of the number of the transmission object point group data of each cell in the first region is equal to or less than the upper limit of the number of the transmission object point group data of each cell in the second region, and
wherein the processing unit selects the point group data of the number equal to or less than the upper limit as the transmission object data in each cell.

6. The data transmission apparatus according to claim 3, wherein the first region contains a peripheral region of an end effector driven by the actuator.

7. The data transmission apparatus according to claim 3, wherein the first region is specified by the remote control terminal.

8. The data transmission apparatus according to claim 3, wherein each of the plurality of cells is a cell prescribed by a straight line parallel to a direction of a virtual sight line, a first straight line parallel to a direction orthogonal to the direction of the virtual sight line, and a second straight line orthogonal to the direction of the virtual sight line and the first straight line,
wherein a region prescribed by the plurality of visible cells when seeing the direction of the virtual sight line from a virtual viewpoint is set as the first region, and
wherein a region prescribed by a plurality of invisible cells when seeing the direction of the virtual sight line from the virtual viewpoint is set as the second region.

9. The data transmission apparatus according to claim 8, wherein all of the point group data in the second region are excluded from the transmission object data.

10. The data transmission apparatus according to claim 1, wherein the processing unit selects data which are obtained based on a result of main component analysis to the point group data in the predetermined three-dimensional region, as the transmission object data in the predetermined three-dimensional region.

11. The data transmission apparatus according to claim 10, wherein when values of eigenvalues d1, d2, and d3 which are obtained by the main component analysis is d1>>d2≈d3≈0, the processing unit selects a peculiar vector e1 corresponding to the eigenvalue d1 and the eigenvalue d1 as the transmission object data in the predetermined three-dimensional region.

12. The data transmission apparatus according to claim 10, wherein when values of eigenvalues d1, d2, and d3 which are obtained by the main component analysis are d1>d2>>d3≈0, the processing unit selects a peculiar vector e1 corresponding to the eigenvalue d1, the eigenvalue d1, a peculiar vector e2 corresponding to the eigenvalue d2, and the eigenvalue d2 as the transmission object data in the predetermined three-dimensional region.

13. The data transmission apparatus according to claim 1, wherein the communication section transmits the transmission object data to the remote control terminal, and then transmits at least a part of data of the acquired point group data other than the transmission object data.

14. The data transmission apparatus according to claim 1, further comprising:
a controller configured to use all the acquired point group data to autonomously control the actuator.

15. The data transmission apparatus according to claim 1, wherein the communication section transmits measured color data together with the transmission object data to the remote control terminal.

16. A data transmission system comprising:
a data transmission apparatus; and
a remote control terminal,
wherein the data transmission apparatus comprises:
an actuator controlled in response to a control signal from a remote control terminal;
a three-dimensional sensor configured to acquire point group data showing three-dimensional coordinates;
a processing unit configured to select transmission object data based on the point group data; and
a communication section configured to transmit the transmission object data to the remote control terminal,
wherein the processing unit sets an upper limit of a data quantity of the transmission object data which belong to a predetermined three-dimensional region, and
wherein the remote control terminal generates a display image of a measurement object shape based on the transmission object data transmitted from the data transmission apparatus.

17. A data transmission method by a data transmission apparatus having an actuator controlled in response to a control signal from a remote control terminal, comprising:
acquiring point group data showing three-dimensional coordinates;
selecting transmission object data based on the point group data; and
transmitting the transmission object data to the remote control terminal,
wherein the selecting comprises selecting the transmission object data such that a data quantity of the transmission object data belonging to a predetermined three-dimensional region is an upper limit or below set by a processing unit of the data transmission apparatus.

18-31. (canceled)

32. A non-transitory recording medium which stores a data transmission program for making a computer execute a data transmission method by a data transmission apparatus having an actuator controlled in response to a control signal from a remote control terminal, wherein the data transmission method comprises:
acquiring point group data showing three-dimensional coordinates;
selecting transmission object data based on the point group data; and
transmitting the transmission object data to the remote control terminal,
wherein the selecting comprises selecting the transmission object data such that a data quantity of the transmission object data belonging to a predetermined three-dimensional region is an upper limit or below set by a processing unit of the data transmission apparatus.

33. The data transmission apparatus according to claim 1, wherein the processing unit selects the point group data to be transmitted from among the point group data and excludes point group data which exceeds the upper limit of the data quantity, from the transmission object, and
wherein the transmission object data is the selected point group data.
